(19) United States
(12) Patent Application Publication
(10) Pub. No.: US 2022/0229846 A1
(43) Pub. Date: Jul. 21, 2022

(54) IMPLEMENTING FIELD-LEVEL COMMENTS AND PRESENCE DETECTION

(71) Applicant: salesforce.com, inc., San Francisco, CA (US)

(72) Inventors: Nathaniel Botwick, San Francisco, CA (US); Norris Lee, San Francisco, CA (US); Kevin A. Gibbs, San Francisco, CA (US); John Arian Brock, Olympic Valley, CA (US); Jeffrey Davis, Palm Springs, CA (US); Gregory Alan Rewis, Redwood City, CA (US); Joel Benjamin Allen, Clemmons, NC (US); Christopher M. Bosko, Raleigh, NC (US); Jason Wagner, Raleigh, NC (US); Scott Goodfriend, Berkeley, CA (US)

(21) Appl. No.: 17/153,590

(22) Filed: Jan. 20, 2021

(51) Int. Cl. G06F 16/25; G06F 16/2457; G06F 16/23; H04L 12/58

(52) U.S. Cl. CPC G06F 16/252; H04L 51/043; G06F 16/235; G06F 16/24573

(57) ABSTRACT

Methods, systems, and devices for data processing are described. According to the techniques described herein, a device (e.g., an application server) may render a first graphical user interface including a first view of a first data record, the first view including a first field. The device may receive, via the first graphical user interface, a user input including a field-level comment for the first field. The first view further includes the field-level comment and a first field-level visual indicator indicating that the field-level comment is associated with the first field. The device may also render a second graphical user interface including a second view of a set of data records including the first data record. In some cases, the second view omits the first field and includes the field-level comment and a second record-level visual indicator indicating that the field-level comment is associated with the first data record.

### FIELD OF TECHNOLOGY

The present disclosure relates generally to database systems and data processing, and more specifically to implementing field-level comments and presence detection.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support a number of applications and pages for viewing CRM information, updating data records, or performing other CRM or data-related activities. Users may access these applications and pages on different user devices. In addition, a cloud platform (e.g., CRM systems) may support multiple data records or data objects for multiple tenants. Each data record may include one or more fields. Some systems supporting user interaction with data records can be improved.

### BRIEF DESCRIPTION OF THE DRAWINGS

FIG. 1 illustrates an example of a system for data processing that supports implementing field-level comments and presence detection in accordance with aspects of the present disclosure.

FIG. 2 illustrates an example of a system that supports implementing field-level comments and presence detection in accordance with aspects of the present disclosure.

FIG. 3 illustrates an example of a computing system that supports implementing field-level comments and presence detection in accordance with aspects of the present disclosure.

FIG. 4 illustrates an example of a user interface that supports implementing field-level comments and presence detection in accordance with aspects of the present disclosure.

FIG. 5 illustrates an example of a user interface that supports implementing field-level comments and presence detection in accordance with aspects of the present disclosure.

FIG. 6 illustrates an example of a user interface that supports implementing field-level comments and presence detection in accordance with aspects of the present disclosure.

FIG. 7 shows a block diagram of an apparatus that supports implementing field-level comments and presence detection in accordance with aspects of the present disclosure.

FIG. 8 shows a block diagram of a data processing module that supports implementing field-level comments and presence detection in accordance with aspects of the present disclosure.

FIG. 9 shows a diagram of a system including a device that supports implementing field-level comments and presence detection in accordance with aspects of the present disclosure.

FIGS. 10 through 12 show flowcharts illustrating methods that support implementing field-level comments and presence detection in accordance with aspects of the present disclosure.

### DETAILED DESCRIPTION

A system (e.g., a cloud-based system supporting customer relationship management (CRM) solutions) may support a number of applications, pages, or both for displaying components. These components may display information, perform defined actions, provide links to other applications (e.g., third-party applications outside the cloud-based system), or provide any number of other features as indicated in the component definitions. A tenant of a multi-tenant database may store information and data for users, customers, organizations, etc. in a database. As depicted herein, a cloud platform (e.g., CRM systems) may support multiple data records or data objects for multiple tenants. Each data record may include one or more fields. For example, a data record “Opportunity” may include fields such as “Opportunity owner,” “Opportunity name,” “Account name,” “Billing address,” “Phone,” “Amount,” “Expected Revenue,” “Close Date,” “Stage,” etc. A user may input a comment in a user interface related to the data record such that the comment is viewable as being associated with the data record. Some systems may support commenting on a data record at a record level. As such, the comment may be associated with the record, but not specifically associated with a field of the record. That is, some systems may not support commenting at the field-level of a data record.

Various aspects of the present disclosure provide techniques for implementing field-level comments and presence detection. Techniques described herein may support field-level commenting in a multi-tenant system, that may simultaneously be used by multiple users interacting with a field associated with a data record. In particular, one or more aspects of the present disclosure provides a solution for supporting commenting at the field-level of a data record by utilizing a user interface displaying multiple fields of a data record in which a user may input a comment associated with a field of the record. In some instances, an application server may render a first graphical user interface including a first view of a first data record. In some cases, the first view may include a first field of a set of fields of the first data record. The application server may receive, via the first graphical user interface, a user input including a field-level comment for the first field. For example, a user interface including a data record “Opportunity” may receive a field-level comment associated with the field “Stage,” and the field-level comment may be displayed on a window overlaid on the user interface. In some examples, the application server may render a second graphical user interface including a second view of a set of data records including the first data record. That is, the application server may display the field-level comment on a second user interface that shows the record in a different view, but retains the field-level commenting functionality. In some instances, the second view may omit the first field and may include the received field-level comment and a second record-level visual indicator indicating that the field-level comment is associated with the first data record. For example, the second user interface may show a list of different data records and the field-level comments in a pane adjacent to the list.

Additionally or alternatively, the present disclosure may support indicating a presence of users (e.g., whether a user interacting with a record is online or otherwise available). In some examples, the application server may display real-time cursor movements of different users on a user interface displaying one or more data records. In some examples, the application server may provide for an initiation of an audio/video communication with an active user based on detecting a presence of active users. For example, the application server may receive, via a graphical user interface, a user input to initiate a communication with at least one user of a set of users based on a presence indicator. In response to the user input, the application server may render another graphical user interface including an overlay over a view of one or more data records. In some examples, the overlay may include a view of an active communication with the at least one user. According to aspects described herein, field-level commenting may be supported in applications displayed on user devices, thereby providing for an improved user interface for interacting with multiple views of data records. These improvements may address deficiencies in existing user interfaces that only support record-level commenting.

Aspects of the disclosure are initially described in the context of an environment supporting an on-demand database service. Aspects of the disclosure are further described with respect to a general system diagram that shows computing components and data flows that support implementing field-level comments and presence detection and diagrams illustrating user interfaces that support the techniques herein. Aspects of the disclosure are further illustrated by and described with reference to apparatus diagrams, system diagrams, and flowcharts that relate to implementing field-level comments and presence detection.

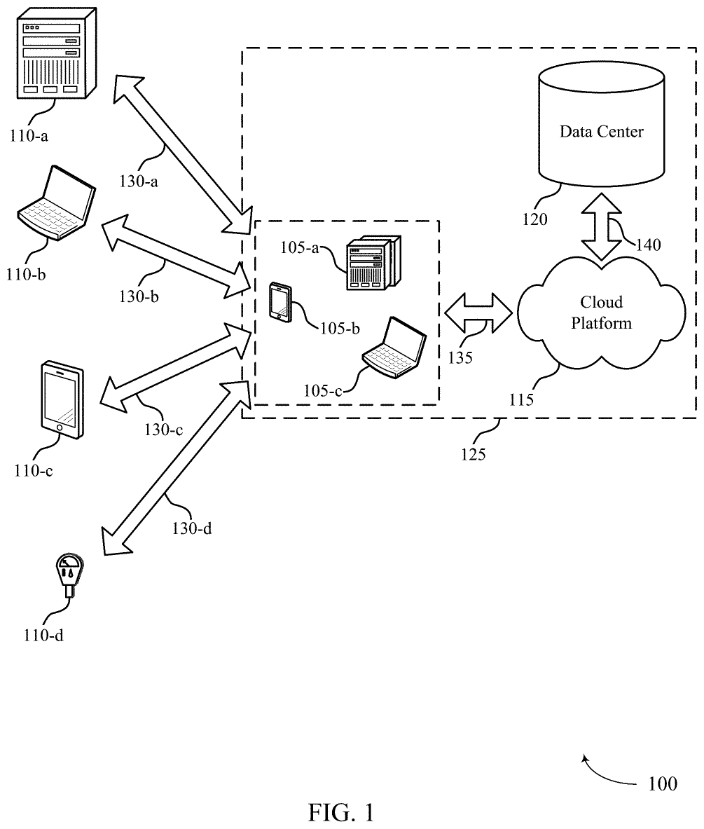

FIG. 1 illustrates an example of a system 100 for cloud computing that supports implementing field-level comments and presence detection in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The data center 120 may be example of a multi-tenant system that supports data storage, retrieval, data analytics, and the like for various tenants, such as the cloud clients 105. As such, each cloud client 105 may be provided with a database instance in the datacenter 120, and each database instance may store various datasets that are associated with the particular cloud client 105. More particularly, each cloud client 105 may have a specific set of datasets that are unique for the cloud client 105. The cloud platform and datacenter 120 support a system that processes set of datasets for a particular cloud client 105. Additionally or alternatively, the subsystem 125 may support a number of applications, pages, or both for displaying components related to CRM processes, data management, messaging, or any other supported functionality. These applications, pages, and components may support field-level commenting by a user (e.g., an administrative user of an organization). For example, a data record “Opportunity” may include fields such as “Opportunity owner,” “Opportunity name,” “Account name,” “Billing address,” “Phone,” “Amount,” “Expected Revenue,” “Close Date,” “Stage,” etc. A user may input a comment in a user interface related to the data record such that the comment is viewable as being associated with the record. One or more aspects of the present disclosure may support commenting at the field-level of a data record that are rendered on a number of different user interfaces or views.

Conventional systems may support commenting on a data record at the record level. That is, commenting functionality implemented by some systems may not account for a granularity of a data record. Additionally, conventional systems may not implement a commenting functionality across multiple user interfaces or may implement separate commenting functionality for each supported user interface. In such cases, the lack of comment portability across user interfaces may result in both a poor application performance and a poor user experience. For example, record-level comments may not support comments or comment threads related to specific fields of a record, thereby resulting in unorganized commenting panes associated with the record. As such, providing for commenting functionality on a record level may result in a poor user experience due to user interface deficiencies in current systems.

In contrast, the cloud platform and datacenter 120 support a system that supports techniques for implementing field-level comments and presence detection. The system 100 may also improve the user experience at user devices running the application by enhancing the user interface and ability to interact with the user interface. An application supporting field-level commenting in a multi-tenant system may simultaneously be used by multiple users interacting with a field associated with a data record. The application server (hosted in subsystem 125) may render a different view for the data record in one or more user interfaces (e.g., a first view of a first data record including a first field of a set of fields of the first data record and a second view omitting the first field and including at least one field-level comment). In one example, the cloud platform and datacenter 120 may support commenting at the field-level of a data record by utilizing a user interface displaying multiple fields of a data record in which a user may input a comment associated with a field of the record.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

A cloud client 105 may be an example of a company that sells widgets around the world. The company maintains a data record named “Opportunity” that lists opportunities for selling different versions of the widget. In some instances, an application server hosted on the cloud client 105 may render a first graphical user interface including a first view of a first data record (e.g., “Opportunity”). In some cases, the first view may include a first field of the first data record. The application server may receive, via the first graphical user interface, a user input including a field-level comment for the first field. In some examples, the user may select to input a new comment for a first field or edit an existing comment. In some cases, the application server may render a user interface including a data record “Opportunity,” and may receive a field-level comment associated with the field “Stage.” The application server may then display the field-level comment on a window overlaid on the user interface displaying multiple fields of the data record “Opportunity.” One or more aspects of the present disclosure further provides for portability of the field-level comments across multiple user interfaces.

In some examples, the application server may render a second graphical user interface including a second view of a set of data records including the first data record. If the user switches to a second user interface supported by the application server, the application server may display the field-level comment on a window overlaid on the second user interface. That is, the application server may display the field-level comment received via the first user interface on a second user interface that shows the record in a different view. Thus, the application server may retain the field-level commenting functionality across various user interfaces.

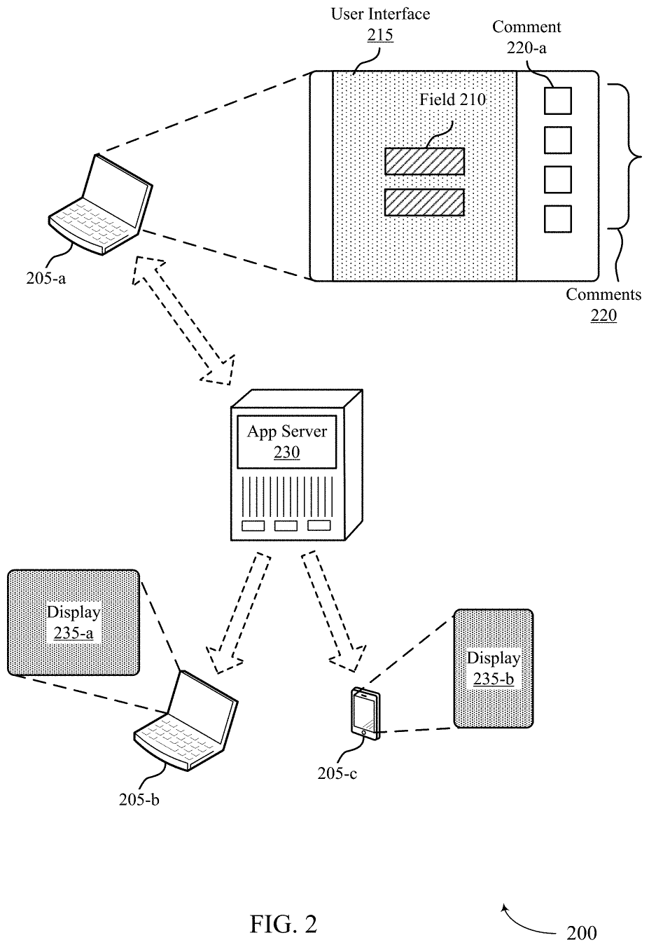

FIG. 2 illustrates an example of a system 200 that supports implementing field-level comments and presence detection in accordance with aspects of the present disclosure. The system 200 may include a number of user devices 205, which may be examples of cloud clients 105 or contacts 110 as described with reference to FIG. 1. The server 230 may be examples of aspects of the cloud platform 115 and the datacenter 120 of FIG. 1. For example, the server 230 may be represent various devices and components that support an analytical data system as described herein. The server 230 may support a multi-tenant database system, which may manage various datasets that are associated with specific tenants (e.g., cloud clients 105).

A user (e.g., an administrative user) may operate a first user device 205-a running an application to implement field-level comments. Using user device 205-a and the application, the user may input a field-level comment related to a displayed field 210 associated with a data record. In some examples, the field-level comment may be displayed in different user interfaces 215. In some examples, the same application (e.g., supported by a single underlying metadata file or container) may be displayed differently on different user devices 205 corresponding to different user interface types. A user accessing an application or page on a user device 205-b (e.g., a laptop or desktop computer corresponding to a large form factor) may view a first display 235-a, while a user accessing the same application or page on a user device 205-c (e.g., a mobile phone corresponding to a small form factor) may view a second display 235-b. In some examples, the user accessing an application or page on a user device 205 may view or otherwise interact with field-level comments on a first view of a data record (via a display 235) and may subsequently view or otherwise interact with field-level comments on a second view of the data record.

The application server may allow implementation of commenting at the field-level of a data record. That is, the application server may allow a user to comment on a field of a data record displayed on different types of user interfaces rendered on user devices 205 (e.g., mobile phones, smartwatches, tablets, desktops, laptops, etc.). With custom commenting support at a user devices 205 (e.g., including at a mobile device), the user device 205 may support switching between different user interfaces, where a first user interface includes a first view of a data record and a second user interface includes a second view of the data record. In addition, a user device 205 may display data records that includes multiple fields 210 and an overlaid window including comments 220 associated with one or more of the displayed fields. The application server may also support editing, adding or deleting field-level comments 220 rendered on a user interface or multiple user interfaces. Furthermore, the application server may support rending a different user interface 215 that shows the record in a different view, but retains the field-level commenting functionality.

To support different renderings for different user interfaces on displays 235, the system 200 may include commenting options for users (e.g., developers, administrative users, etc.) across each user interface. For example, the system 200 may support a display of different fields associated with a data record. In another example, the system 200 may support a display of multiple data records without displaying the fields associated with each data record. The comments 220 (e.g., comments 220 received by the system 200) and any number of additional edits received for the comments 220 may support rendering in any number of user interfaces 215. For example, a subset of comments 220 may only be applicable (e.g., may support rendering) for one user interface 215, while other comments 220 may be applicable for multiple user interfaces 215. In some cases, comments 220 displayed on multiple user interfaces 215 may render differently in different user interfaces 215. In some examples, a user interface type may refer to a type of device, a form factor, or some combination of these. In one specific example, at the code level, user interface types may be defined by form factors, while at the user interface level, the user interface types may be defined by device types. Different form factors may refer to different user interface sizes, such as “Small,” “Medium,” “Large,” etc. Different device types may refer to different physical devices, such as mobile phones, smartwatches, tablets, desktops, laptops, etc. In some cases, certain form factors may be associated with certain device types. For example, a “Small” form factor and a mobile phone may be examples of equivalent user interface types. Similarly, a “Large” form factor may be equivalent to a desktop.

One or more aspects of the present disclosure may support rendering for comments 220 across different user interfaces 215, applications, pages, or some combination of these. In a first example, a user interface 215 may include a data record “Opportunity.” The data record “Opportunity” may include fields 210 such as “Opportunity owner,” “Opportunity name,” “Account name,” “Billing address,” “Phone,” “Amount,” “Expected Revenue,” “Close Date,” “Stage,” etc. An application server 230 may render a user interface 215 including a first view of a first data record “Opportunity.” In some cases, the first view may include a first field 210 of a set of fields of the first data record. A user may view the first view of a first data record “Opportunity” using a user device 205. In some examples, the user may input a comment in a user interface related to the data record. That is, the user may input a comment using a display 235 rendered on the user device 205. The user may input a comment such that the comment is viewable as being associated with the data record. For example, the application server 230 may render the first view on a user interface 215 such that the first view includes the received field-level comment 220-a and a first field-level visual indicator indicating that the received field-level comment is associated with the first field 210. As one example depicted herein, a user interface 215 including a data record “Opportunity” may receive a field-level comment associated with the field “Stage,” and the field-level comment 220-a may be displayed on a window including multiple comments 220 overlaid on the user interface 215.

An application launcher at a user device may indicate the applications or pages that are activated and available for the user device. In some cases, activating an application or page may push the application or page to a centralized system or server (e.g., an applications server 230). Other user devices 205 may then access and display the activated application or page by interacting with the application server 230 (e.g., via an API). In some cases, when operating online, running an application or page at a user device 205 may involve a link between the user device 205 and the application server 230 storing information about the application or page (e.g., a display template, the comments 220 in a window overlaid on the user interface 215, etc.). In other cases, when operating offline, the user device 205 may store the information about the application or page locally. In some examples, the user device 205 may initially download support for the application or page from the application server 230 before running the application or page without requiring further interactions with the application server 230.

In some examples, a user may be able to comment on an application once the application is activated and displayed on a user interface 215. Additionally, a user may navigate between applications or pages using user-defined navigation items in the applications or the application launcher. These navigation items may be selected or defined by an administrative user or by an end user running the applications on the user device 205. For example, an end user may modify a configuration for the navigation menu using a setup user interface. In some cases, the navigation menu may include a set of standard items and a number of custom items. Modifying the navigation menu may modify underlying metadata describing a set of mobile navigation menu items. The metadata for each navigation menu item may be stored in an AppMenultem and may be retrieved by a device 205 at runtime via a navigation-menu Connect API (which in turn may implement an internal API, for example, at the application server 230). In some case, a user device may store an indication of a last used application, and may automatically re-render the display 235 to show the last used application when the user device identifies a user profile.

Upon navigating to a second user interface, the application server 230 may render the second user interface 215 on the user device 205. In some examples, the second user interface 215 may include a second view of a set of data records including the first data record. That is, the application server 230 may display the field-level comment 220-a on a second user interface that shows the record in a different view, but retains the field-level commenting functionality. As depicted herein, the second view may omit the first field and may include the received field-level comment and a second record-level visual indicator indicating that the field-level comment is associated with the first data record. For example, the second user interface 215 may show a list of different data records and the field-level comments in a pane adjacent to the list.

Some comments 220 that support rendering on multiple user interfaces 215 may render differently for different user interfaces 215. In a first example, a comment 220 may be an example of a responsive comment. A responsive comment may render in response to a prior comment (e.g., as a reply of a prior comment). In particular, a responsive comment may be based on some underlying content or information. In a second example, a comment 220 may be an example of an input to edit an existing comment. In some examples, the comment 220 may be adaptive comments. An adaptive comment may be displayed differently in different user interfaces 215.

In some examples, the application server 230 may support multiple comments associated with a single field of a data record. For instance, the application server 230 may receive a second user input including a second field-level comment. In some examples, the first view further includes the received field-level comment and the received second field-level comment, where the first field-level visual indicator indicates a number of field-level comments associated with the first field. As one example, with reference to the data record “Opportunity,” the application server 230 may receive two comments 220 associated with a field “Stage.” The user interface 215 may display a field-level visual indicator indicating a number of field-level comments associated with the field “Stage.” For instance, the application server 230 may display a number 2 adjacent to the field “Stage” to indicate that there are two comments associated with the field “Stage.”

In addition to field-level commenting support, the present disclosure may support indicating a presence of users (e.g., whether a user interacting with a record is online or otherwise available). In some examples, the application server 230 may display real-time cursor movements of different users on a user interface displaying one or more data records. In some examples, the application server 230 may provide for an initiation of an audio/video communication with an active user based on detecting a presence of active users. In some examples, the application server 230 may display a presence indicator associated with each active user. The application server 230 may render an “online” indication for display on the user interface. Upon displaying the presence indication, the application server 230 may receive an input to initiate a communication with one or more of the active users. For example, the application server 230 may receive, via a user interface, a user input to initiate a communication with at least one user of a set of users based on the presence indicator. In response to the user input, the application server 230 may render another user interface 215 including an overlay over a view of one or more data records (not shown). In some examples, the overlay may include a view of an active communication with the at least one user.

Based on the implementation of field-level commenting described herein, display 235-a for a first user interface 215 (e.g., a desktop, laptop, mobile, etc.) may display field-level comments on a first application page. In addition, display 235-a or a second display 235-b for a second user interface 215 may field-level comments on a second application page. As depicted herein, both user interfaces 215 may provide for field-level commenting on a window overlaid on different views of data records, thereby enhancing user experience. The concepts and techniques described with reference to FIG. 2 are further described with respect to the following figures.

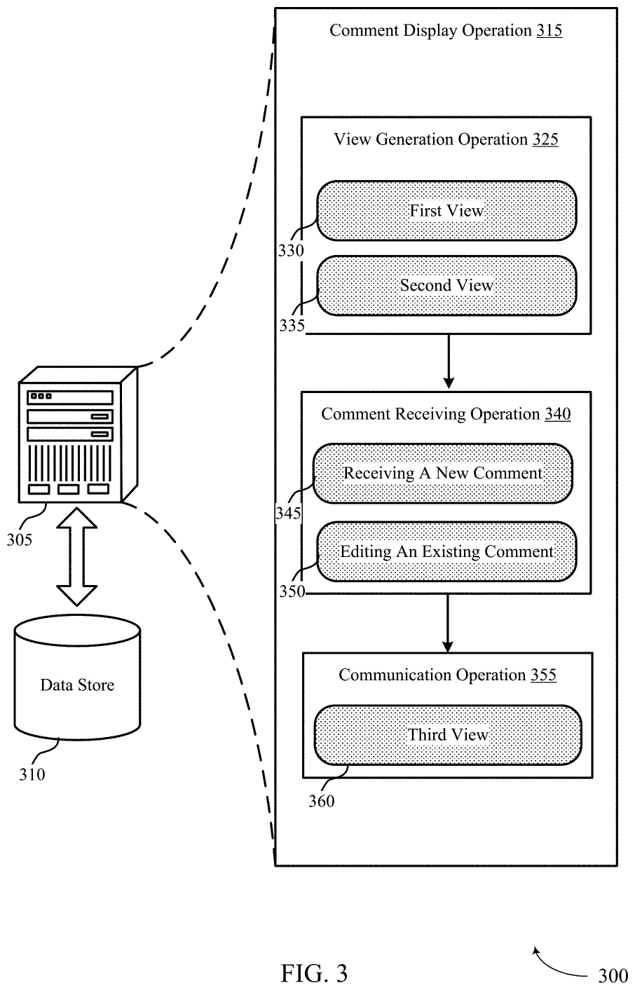

FIG. 3 illustrates an example of a computing system 300 that supports implementing field-level comments and presence detection in accordance with aspects of the present disclosure. The computing system 300 may include a device 305 (e.g., an application server) and a data store 310. In some cases, the functions performed by the device 305 (such as application server) may instead be performed by a component of the data store 310. A user device (not shown) may support an application for CRM processes, data management, messaging, or any other supported functionality. Specifically, a user device in combination with the device 305 may support an application that provides for implementing field-level comments and presence detection. A user operating the user device may interact with the application to input and edit comments in a data field displayed on the device 305, where the device 305 may retain the field-level commenting functionality across different displays.

According to one or more aspects of the present disclosure, a user device may optionally display an interactive interface for receiving a field-level comment (from a user). In some examples, the user device may display the interactive interface for receiving a comment (from a user) associated with a field of a data record. Prior to receiving the comment, the user device may receive a request to initialize an application to display one or more data records. Alternatively, the device 305 may display one or more data records without receiving a request from a user device. In some cases, the interface at the user device may run as a webpage within a web browser (e.g., as a software as a service (SaaS) product). In other cases, the interface may be part of an application downloaded onto the user device. A user operating the user device may input information into the user interface to specify aspects of the request to display a view of a data record. In some cases, a user may be associated with a user credential or user ID, and the user may log on to the user device using the user credential. As described herein, the device 305 in conjunction with the data store 310 may perform a comment display operation 315 to support field-level commenting and presence detection.

According to one or more aspects of the present disclosure, the comment display operation 315 may be performed by the device 305, such as a server (e.g., an application server, a database server, a server cluster, a virtual machine, a container, etc.) in conjunction with a user device. Although not shown in FIG. 3, the comment display operation 315 may be performed by a user device, a data store 310, or some combination of these or similar devices. In some cases, the device 305 may be a component of a subsystem 125 as described with reference to FIG. 1. The device 305 may support computer aided data science, which may be performed by an artificial intelligence-enhanced data analytics framework. The device 305 may be an example of a general analysis machine and, as such, may perform data analytics and display field-level comments.

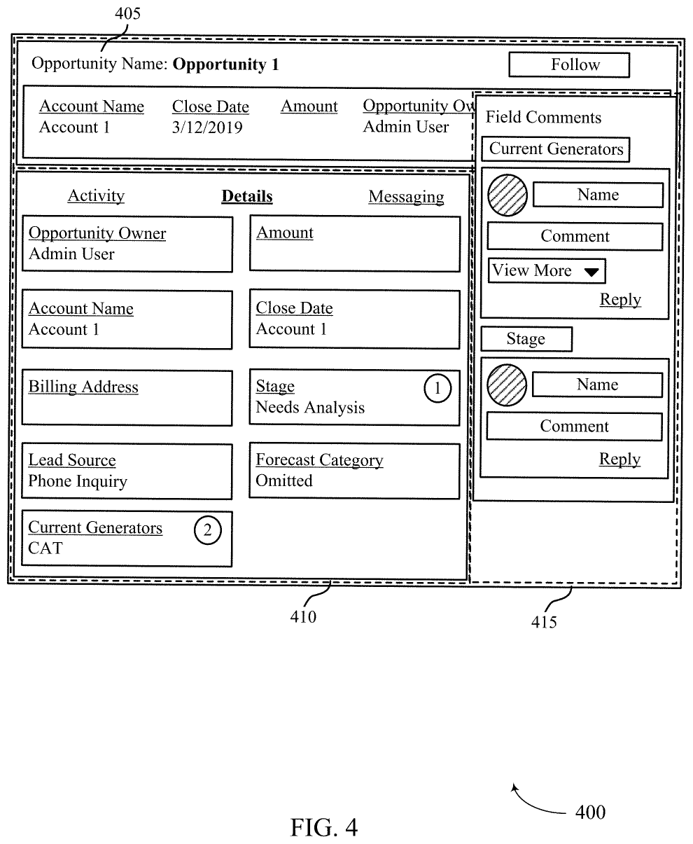

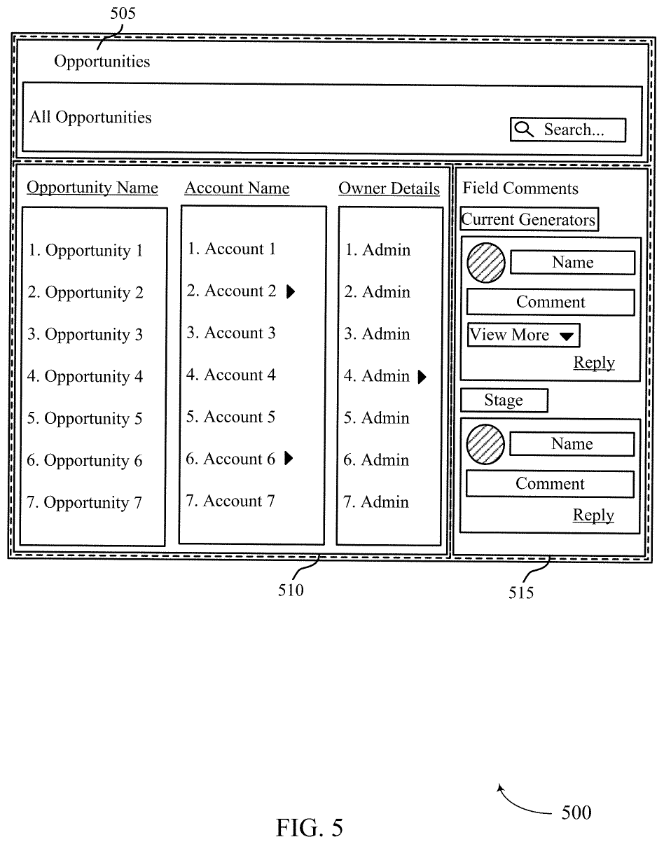

According to one or more aspects of the present disclosure, the device 305 may receive a request to render a first view of a data record from one or more user devices (not shown). Upon receiving the request, the device 305 may perform a view generation operation 325. The device 305 may render a first graphical user interface including a first view 330 of a first data record. In some cases, the first view may include a first field of a set of fields of the first data record. Further aspects of the first view 330 of the first data record are described with reference to FIG. 4. Additionally or alternatively, the device 305 may render second graphical user interface including a second view 335 of a set of data records including the first data record. Further aspects of the second view 335 of the first data record are described with reference to FIG. 5.

In some instances, the device 305 may perform a comment receiving operation 340. As part of the comment receiving operation 340, the device 305 may receive a new comment 345 or a request to edit an existing comment 350. In some examples, the device 305 may receive, via the first graphical user interface, a user input including a field-level comment for the first field. As one example, a data record “Opportunity” may include fields such as “Opportunity owner,” “Opportunity name,” “Account name,” “Billing address,” “Phone,” “Amount,” “Expected Revenue,” “Close Date,” “Stage,” etc. The first view of the data record “Opportunity” may include fields such as “Opportunity owner,” “Opportunity name,” “Account name,” “Billing address,” “Phone,” “Amount,” “Expected Revenue,” “Close Date,” “Stage.” The device 305 may receive a user input to add a field-level comment to the field “Stage.” Upon receiving the new comment 345, the device 305 may update the first view to include the received field-level comment and a first field-level visual indicator indicating that the received field-level comment is associated with the first field (“Stage”).

Additionally or alternatively, the device 305 may receive, via the first graphical user interface second user input including a second field-level comment. The device 305 may update the first view to include the received field-level comment and the received second field-level comment. In some examples, the first field-level visual indicator may indicate a number of field-level comments associated with the first field. For example, if the device received two comments associated with the field “Stage,” then the device 305 may display a number 2 adjacent to the field “Stage” to indicate that there are two field-level comments associated with the field “Stage.”

In some instances, the device 305 may render a second graphical user interface after receiving at least one field-level comment via the first graphical user interface. The second graphical user interface may include a second view of a set of data records including the first data record. In the example of data record “Opportunity,” the second view may include additional data records including the data record “Opportunity.” Additionally, the second view may omit the first field and may include the received field-level comment and a second record-level visual indicator indicating that the field-level comment is associated with the first data record. Referring back to example of data record “Opportunity,” the second view may omit the field “Stage,” and may include a visual indication adjacent to the data record “Opportunity” to indicate that there are one or more field-level comments associated with the data record “Opportunity.”

In some examples where the device 305 receives multiple comments, the second view may include the received field-level comment and the received second field-level comment. In some examples, the record-level visual indicator may indicate that the second field-level comment is associated with the first data record or a second data record (a different data record).

Additionally or alternatively, the device 305 may receive, via the first graphical user interface, a second user input to edit the field-level comment for the first field (“Stage” in the example of the data record “Opportunity”). In such cases, the first view may include the edited field-level comment and the first field-level visual indicator indicating that the edited field-level comment is associated with the first field. Additionally or alternatively, the second view may include the edited field-level comment and the second record-level visual indicator indicating that the edited field-level comment is associated with the first data record.

In some examples, the device 305 may receive, via the second graphical user interface, a second user input to edit the field-level comment for the first field (“Stage” in the example of the data record “Opportunity”). In such cases, the second view omits the received field-level comment and includes the edited field-level comment.

The device 305 may further perform a communication operation 355. The device 305 may receive, via the first graphical user interface and in response to the user input, a second user input to initiate a communication with at least one user of a set of users based on a presence indicator. In such cases, the first view may also include the presence indicator indicating a presence of each user of the set of users. Upon receiving the second user input to initiate a communication, the device 305 may render display of a third view 360. For example, the device 305 may render a third graphical user interface including an overlay over the first view of the first data record. In some examples, the overlay may include a view of an active communication with the at least one user. As depicted herein, the communication with the at least one user may include at least one of an audio communication, a video communication, a written communication, or a combination thereof.

FIG. 4 illustrates an example of a user interface 400 that supports implementing field-level comments and presence detection in accordance with aspects of the present disclosure. The user interface 400 may correspond to a desktop or mobile or other user interface type. In some cases, additional user interface types may be supported for implementing field-level commenting. The user interface 400 may support a first view of a data record.

As depicted herein, a user of a device may be associated with a tenant of a multi-tenant database which has been using the cloud platform for data management. The user interface 400 may be a part of a cloud platform that supports multiple data records. The user interface 400 may display a first view of a first data record. As depicted in the example of FIG. 4, the first view rendered in user interface 400 may include a first field of a set of fields of the first data record. The user interface 400 may include a box 405 including a name of the data record Opportunity. In the example of FIG. 4, the name of the Opportunity is “Opportunity 1.”

The user interface 400 may include a box 410 displaying the details associated with the data record “Opportunity.” For example, the data record “Opportunity” may include fields such as “Opportunity owner,” “Opportunity name,” “Account name,” “Billing address,” “Lead Source,” “Amount,” “Close Date,” “Stage,” “Forecast Category,” etc. The user interface 400 may support field-level commenting on one or more of the fields of the data record. In some examples, the application server rendering the display of the user interface 400 may receive, via the user interface 400, a user input including a field-level comment for a first field. The application server may display the received field-level comment and a first field-level visual indicator indicating that the received field-level comment is associated with the first field. In the example of FIG. 4, the application server may receive a user input including at least one field level comment for the field “Current Generators” and/or at least one field level comment for the field “Stage.”

The user interface 400 may include a comment box 415 displayed on a window overlaid on the user interface 400 displaying the various fields associated with a data record. In some examples, the comment box 415 may include multiple field comments. As depicted in FIG. 4, the comment box 415 may include the name of the field associated with the field-level comment, a name of the commenter, an initial or other identification of the commenter, and an option to reply to the comment. In addition, the user interface 400 may display a field-level visual indicator indicating that a received field-level comment is associated with a field. For instance, the number 2 adjacent to the field “Current Generators” may indicate that there are two comments associated with the field “Current Generators.” Similarly, the number 1 adjacent to the field “Stage” may indicate that there is one comment associated with the field “Stage.” The comment box 415 displays the name of the field “Current Generators,” a name of the commenter, an initial or other identification of the commenter, an option to view additional comments (as there are multiple comments associated with the field “Current Generators”) and an option to reply to the comment. In addition, the comment box 415 displays the name of the field “Stage,” a name of the commenter, an initial or other identification of the commenter, and an option to reply to the comment. In some examples, the user interface 400 may include an additional indicator indicating that the received field-level comment is unread. In some cases, components rendered in one user interface may be imported to another user interface (shown in FIG. 5). As illustrated herein, the field-level commenting in user interface 400 may improve application performance and user experience.

FIG. 5 illustrates an example of a user interface 500 that supports implementing field-level comments and presence detection in accordance with aspects of the present disclosure. The user interface 500 may correspond to a desktop or mobile or other user interface type. In some cases, additional user interface types may be supported for implementing field-level commenting. As depicted with reference to FIG. 4, the user interface 400 may support a first view of a data record and as depicted with reference to FIG. 5, the user interface 500 may support a second view of the data record.

According to one or more aspects, a user of a device may be associated with a tenant of a multi-tenant database which has been using the cloud platform for data management. The user interface 500 may be a part of a cloud platform that supports multiple data records. The user interface 500 may display a second view of a data record. for instance, the user interface 500 may display the second view of a set of data records including the first data record. As depicted in the example of FIG. 5, the second view rendered in user interface 500 may include a set of data records. The user interface 500 may include a box 505 indicating that the user interface 500 includes multiple data records “Opportunities.” In addition, the user interface 500 provides for an option to search for a particular data record.

The user interface 500 may include a box 510 displaying the details associated with multiple data records. For example, the box 510 may include the Opportunity Names, the Account Names, and the Owner Details. For instance, the Opportunity Names may include names such as “Opportunity 1,” “Opportunity 2,” “Opportunity 3,” “Opportunity 4,” “Opportunity 5,” “Opportunity 6,” and “Opportunity 7.” In addition, the Account Names may include names such as “Account 1,” “Account 2,” “Account 3,” “Account 4,” “Account 5,” “Account 6,” and “Account 7.” and the Owner Details may include details about each opportunity (e.g., “Opportunity 1,” “Opportunity 2,” “Opportunity 3,” “Opportunity 4,” “Opportunity 5,” “Opportunity 6,” and “Opportunity 7”). The user interface 500 may support field-level commenting on one or more of the fields of one or more data records of the set of data records.

As described with reference to FIG. 4, an application server rendering the display of the user interface 400 may receive, via the user interface 400, a user input including a field-level comment for a first field. The application server may display the received field-level comment in the first view of the data record. In the example of FIG. 5, the application server may render a second graphical user interface 500 including a second view of a set of data records including the first data record. The second view omits the first field and includes the received field-level comment and a second record-level visual indicator indicating that the field-level comment is associated with the first data record. As described herein, the application server may receive a user input including at least one field level comment for the field “Current Generators” and/or at least one field level comment for the field “Stage.” In the second view displayed in user interface 500, the application server may omit the field “Current Generators” and/or “Stage,” but includes the received field-level comment and a second record-level visual indicator indicating that the field-level comment is associated with a data record.

The user interface 500 may include a comment box 515 displayed on a window overlaid on the user interface 500 displaying a set of data records. In some examples, the comment box 515 may include multiple field comments. As depicted in FIG. 5, the comment box 515 may include the name of the field associated with the field-level comment, a name of the commenter, an initial or other identification of the commenter, and an option to reply to the comment. In addition, the user interface 500 may display one or more record-level visual indicator indicating that a data record is associated with a field-level comment. For instance, “Account 2,” “Account 6,” and “4. Admin” includes record-level visual indicators indicating field-level comments. Additionally or alternatively, the comment box 515 displays the name of the field “Current Generators,” a name of the commenter, an initial or other identification of the commenter, an option to view additional comments (as there are multiple comments associated with the field “Current Generators”) and an option to reply to the comment. In addition, the comment box 515 displays the name of the field “Stage,” a name of the commenter, an initial or other identification of the commenter, and an option to reply to the comment. In some examples, the field-level visual indicator (as shown in FIG. 4) may be the same as the record-level visual indicator (as shown in FIG. 5). In some examples, the field-level visual indicator may be different from the record-level visual indicator.

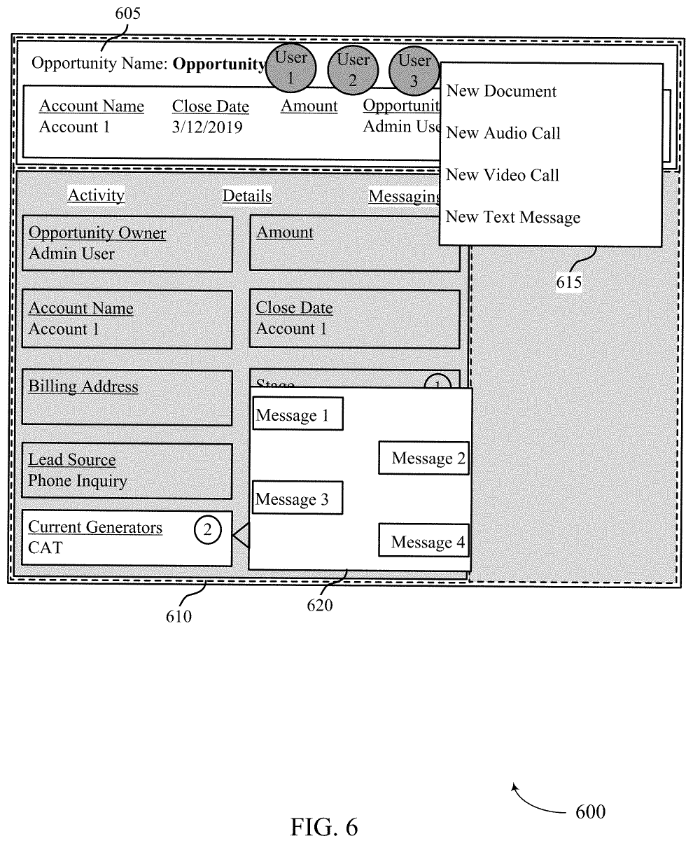

FIG. 6 illustrates an example of a user interface 600 that supports implementing field-level comments and presence detection in accordance with aspects of the present disclosure. The user interface 600 may correspond to a desktop or mobile or other user interface type. In some cases, additional user interface types may be supported for implementing field-level commenting. As depicted with reference to FIG. 6, the user interface 600 may support an overlay on a first view of a data record.

As depicted herein, a user of a device may be associated with a tenant of a multi-tenant database which has been using the cloud platform for data management. The user interface 600 may be a part of a cloud platform that supports multiple data records. As depicted in the example of FIG. 6, the first view rendered in user interface 600 may include a first field of a set of fields of the first data record. The user interface 600 may include a box 605 including a name of the data record Opportunity. In the example of FIG. 6, the name of the Opportunity is “Opportunity 1.” The user interface 600 further includes a box 610 displaying the details associated with the data record “Opportunity.” For example, the data record “Opportunity” may include fields such as “Opportunity owner,” “Opportunity name,” “Account name,” “Billing address,” “Lead Source,” “Amount,” “Close Date,” “Stage,” “Forecast Category,” etc. The user interface 600 may support field-level commenting on one or more of the fields of the data record.

In some examples, the application server rendering the display of the user interface 600 may receive a user input to initiate a communication with at least one user of a set of users based on a presence indicator. In some examples, the first view may include the presence indicator indicating a presence of each user of the set of users. In the example of FIG. 6, the application server may display a presence indicator indicating a presence of “User 1,” “User 2,” and “User 3.” Although not shown in the example of FIG. 6, it may be understood that the input to initiate a communication may be received in addition to an input to add or edit or otherwise interact with a field-level comment. In some examples, the system may recognize that two or more available users are interacting via one or more field-level comments, and the system may suggest initiation of a live video or audio communication between the two or more available users. The communication with the at least one user may include at least one of an audio communication, a video communication, a written communication, or a combination thereof.

The application server may render a third graphical user interface including an overlay over the first view of the first data record. In some examples, the overlay may include a view of an active communication with the at least one user. As depicted in the example of FIG. 6, the user interface 600 may display options 615 to share a new document, start a new audio call, a new video call, or a new text message. In an example where the application server receives an input to initiate a new text message, the application server may render a display of a messaging window 620 including messages exchanges between at least two users.

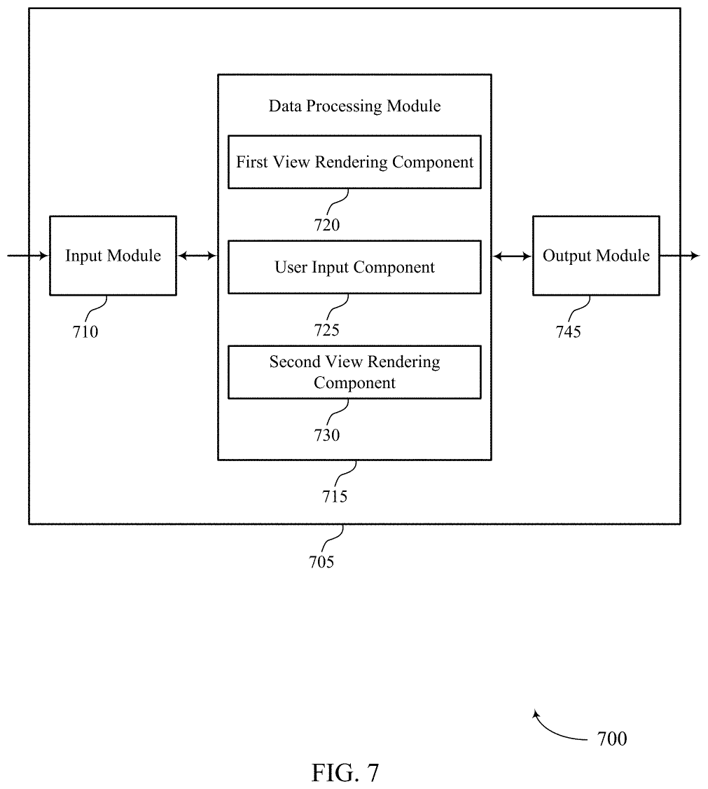

FIG. 7 shows a block diagram 700 of an apparatus 705 that supports implementing field-level comments and presence detection in accordance with aspects of the present disclosure. The apparatus 705 may include an input module 710, a data processing module 715, and an output module 745. The apparatus 705 may also include a processor. Each of these components may be in communication with one another (e.g., via one or more buses). In some cases, the apparatus 705 may be an example of a user terminal, a database server, or a system containing multiple computing devices.

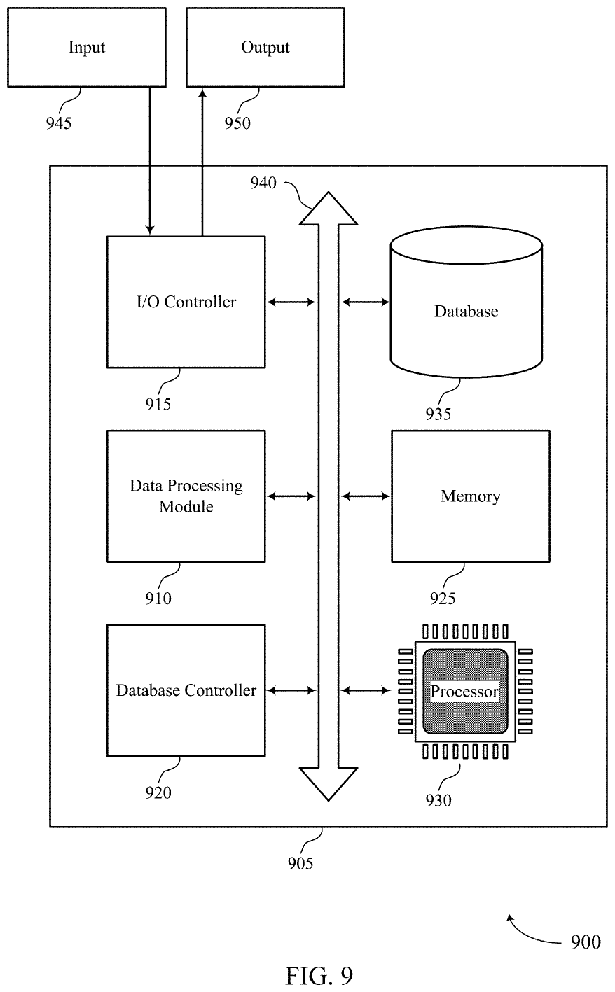

The input module 710 may manage input signals for the apparatus 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the apparatus 705 for processing. For example, the input module 710 may transmit input signals to the data processing module 715 to support implementing field-level comments and presence detection. In some cases, the input module 710 may be a component of an input/output (I/O) controller 915 as described with reference to FIG. 9.

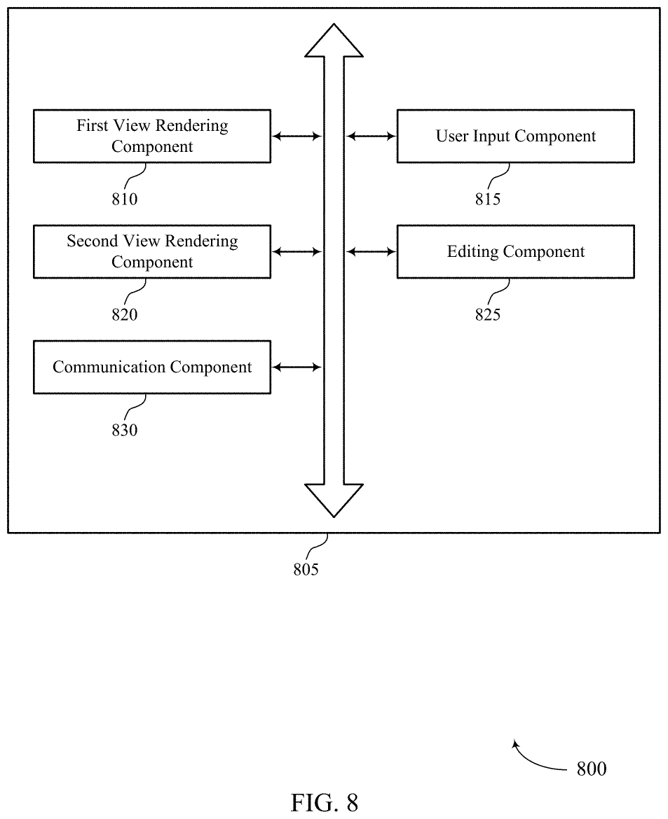

The data processing module 715 may include a first view rendering component 720, a user input component 725, and a second view rendering component 730. The data processing module 715 may be an example of aspects of the data processing module 805 or 910 described with reference to FIGS. 8 and 9.

The data processing module 715 and/or at least some of its various sub-components may be implemented in hardware, software executed by a processor, firmware, or any combination thereof. If implemented in software executed by a processor, the functions of the data processing module 715 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The data processing module 715 and/or at least some of its various sub-components may be physically located at various positions, including being distributed such that portions of functions are implemented at different physical locations by one or more physical devices. In some examples, the data processing module 715 and/or at least some of its various sub-components may be a separate and distinct component in accordance with various aspects of the present disclosure. In other examples, the data processing module 715 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The first view rendering component 720 may render a first graphical user interface including a first view of a first data record, the first view including a first field of a set of fields of the first data record.

The user input component 725 may receive, via the first graphical user interface, a user input including a field-level comment for the first field. In some cases, the first view further includes the received field-level comment and a first field-level visual indicator indicating that the received field-level comment is associated with the first field.

The second view rendering component 730 may render a second graphical user interface including a second view of a set of data records including the first data record. In some cases, the second view omits the first field and includes the received field-level comment and a second record-level visual indicator indicating that the field-level comment is associated with the first data record.

The output module 745 may manage output signals for the apparatus 705. For example, the output module 745 may receive signals from other components of the apparatus 705, such as the data processing module 715, and may transmit these signals to other components or devices. In some specific examples, the output module 745 may transmit output signals for display in a user interface, for storage in a database or data store, for further processing at a server or server cluster, or for any other processes at any number of devices or systems. In some cases, the output module 745 may be a component of an I/O controller 915 as described with reference to FIG. 9.

FIG. 8 shows a block diagram 800 of a data processing module 805 that supports implementing field-level comments and presence detection in accordance with aspects of the present disclosure. The data processing module 805 may be an example of aspects of a data processing module 715 or a data processing module 910 described herein. The data processing module 805 may include a first view rendering component 810, a user input component 815, a second view rendering component 820, an editing component 825, and a communication component 830. Each of these modules may communicate, directly or indirectly, with one another (e.g., via one or more buses).

The first view rendering component 810 may render a first graphical user interface including a first view of a first data record, the first view including a first field of a set of fields of the first data record. The user input component 815 may receive, via the first graphical user interface, a user input including a field-level comment for the first field. In some cases, the first view further includes the received field-level comment and a first field-level visual indicator indicating that the received field-level comment is associated with the first field.

The second view rendering component 820 may render a second graphical user interface including a second view of a set of data records including the first data record. In some cases, the second view omits the first field and includes the received field-level comment and a second record-level visual indicator indicating that the field-level comment is associated with the first data record.

The user input component 815 may receive, via the first graphical user interface, a second user input including a second field-level comment. In some cases, the first view further includes the received field-level comment and the received second field-level comment. In some cases, the first field-level visual indicator indicates a number of field-level comments associated with the first field.

In some cases, the second view may include the received field-level comment and the received second field-level comment. In some cases, the second record-level visual indicator may indicate that the second field-level comment is associated with the first data record or a second data record.

In some cases, the second view may include the received field-level comment and the received second field-level comment. In some cases, the second record-level visual indicator may indicate that the second field-level comment is associated with the first data record or a second data record.

In some cases, the second field-level comment is of a second field of the set of fields, the second view including the received field-level comment, a first indicator of the first field, the received second field-level comment and a second indicator of the first field. In some cases, the second record-level visual indicator indicates that the second field-level comment is associated with a second data record.

The editing component 825 may receive, via the first graphical user interface, a second user input to edit the field-level comment for the first field. In some cases, the first view further includes the edited field-level comment and the first field-level visual indicator indicating that the edited field-level comment is associated with the first field. In some cases, the second view may include the edited field-level comment and the second record-level visual indicator indicating that the edited field-level comment is associated with the first data record.

In some examples, the editing component 825 may receive, via the second graphical user interface, a second user input to edit the field-level comment for the first field. In some cases, the second view omits the received field-level comment and includes the edited field-level comment.

In some cases, the first field-level visual indicator is the same as the second record-level visual indicator. In some cases, the first field-level visual indicator is different from the second record-level visual indicator. In some cases, the first view further includes a third indicator indicating that the received field-level comment is unread.

The communication component 830 may receive, via the first graphical user interface and in response to the user input, a second user input to initiate a communication with at least one user of a set of users based on a presence indicator. In some cases, the first view further includes the presence indicator indicating a presence of each user of the set of users. In some examples, the communication component 830 may render a third graphical user interface including an overlay over the first view of the first data record, the overlay including a view of an active communication with the at least one user.

In some cases, the communication with the at least one user includes at least one of an audio communication, a video communication, a written communication, or a combination thereof.

FIG. 9 shows a diagram of a system 900 including a device 905 that supports implementing field-level comments and presence detection in accordance with aspects of the present disclosure. The device 905 may be an example of or include the components of an application server or an apparatus 705 as described herein. The device 905 may include components for bi-directional data communications including components for transmitting and receiving communications, including a data processing module 910, an I/O controller 915, a database controller 920, memory 925, a processor 930, and a database 935. These components may be in electronic communication via one or more buses (e.g., bus 940).

The data processing module 910 may be an example of a data processing module 715 or 805 as described herein. For example, the data processing module 910 may perform any of the methods or processes described above with reference to FIGS. 7 and 8. In some cases, the data processing module 910 may be implemented in hardware, software executed by a processor, firmware, or any combination thereof.

The I/O controller 915 may manage input signals 945 and output signals 950 for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The database controller 920 may manage data storage and processing in a database 935. In some cases, a user may interact with the database controller 920. In other cases, the database controller 920 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause the processor to perform various functions described herein. In some cases, the memory 925 may contain, among other things, a basic input/output system (BIOS) which may control basic hardware or software operation such as the interaction with peripheral components or devices.

The processor 930 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting implementing field-level comments and presence detection).

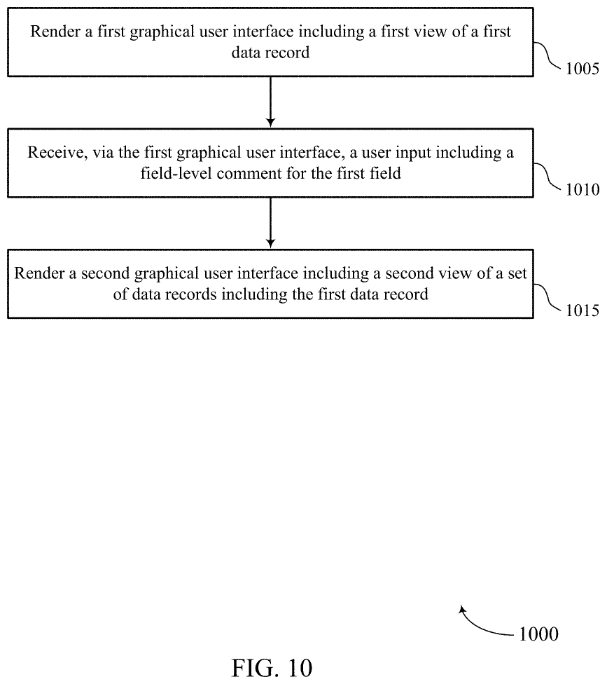

FIG. 10 shows a flowchart illustrating a method 1000 that supports implementing field-level comments and presence detection in accordance with aspects of the present disclosure. The operations of method 1000 may be implemented by an application server or its components as described herein. For example, the operations of method 1000 may be performed by a data processing module as described with reference to FIGS. 7 through 9. In some examples, an application server may execute a set of instructions to control the functional elements of the application server to perform the functions described below. Additionally or alternatively, an application server may perform aspects of the functions described below using special-purpose hardware.

At 1005, the application server may render a first graphical user interface including a first view of a first data record. In some examples, the first view may include a first field of a set of fields of the first data record. The operations of 1005 may be performed according to the methods described herein. In some examples, aspects of the operations of 1005 may be performed by a first view rendering component as described with reference to FIGS. 7 through 9.

At 1010, the application server may receive, via the first graphical user interface, a user input including a field-level comment for the first field. In some examples, the first view may include the received field-level comment and a first field-level visual indicator indicating that the received field-level comment is associated with the first field. The operations of 1010 may be performed according to the methods described herein. In some examples, aspects of the operations of 1010 may be performed by a user input component as described with reference to FIGS. 7 through 9.

At 1015, the application server may render a second graphical user interface including a second view of a set of data records including the first data record. In some examples, the second view omits the first field and includes the received field-level comment and a second record-level visual indicator indicating that the field-level comment is associated with the first data record. The operations of 1015 may be performed according to the methods described herein. In some examples, aspects of the operations of 1015 may be performed by a second view rendering component as described with reference to FIGS. 7 through 9.

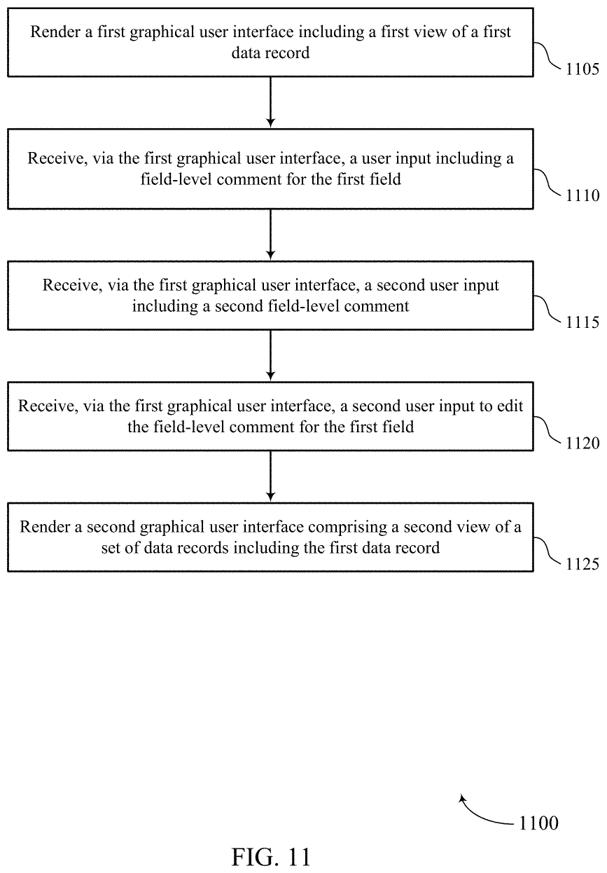

FIG. 11 shows a flowchart illustrating a method 1100 that supports implementing field-level comments and presence detection in accordance with aspects of the present disclosure. The operations of method 1100 may be implemented by an application server or its components as described herein. For example, the operations of method 1100 may be performed by a data processing module as described with reference to FIGS. 7 through 9. In some examples, an application server may execute a set of instructions to control the functional elements of the application server to perform the functions described below. Additionally or alternatively, an application server may perform aspects of the functions described below using special-purpose hardware.

At 1105, the application server may render a first graphical user interface including a first view of a first data record. In some examples, the first view may include a first field of a set of fields of the first data record. The operations of 1105 may be performed according to the methods described herein. In some examples, aspects of the operations of 1105 may be performed by a first view rendering component as described with reference to FIGS. 7 through 9.

At 1110, the application server may receive, via the first graphical user interface, a user input including a field-level comment for the first field. In some examples, the first view may include the received field-level comment and a first field-level visual indicator indicating that the received field-level comment is associated with the first field. The operations of 1110 may be performed according to the methods described herein. In some examples, aspects of the operations of 1110 may be performed by a user input component as described with reference to FIGS. 7 through 9.

At 1115, the application server may receive, via the first graphical user interface, a second user input including a second field-level comment. In some cases, the first view further includes the received field-level comment and the received second field-level comment. In some examples, the first field-level visual indicator indicates a number of field-level comments associated with the first field.

In some examples, a second view may include the received field-level comment and the received second field-level comment, and a second record-level visual indicator may indicate that the second field-level comment is associated with the first data record or a second data record. Additionally or alternatively, the second field-level comment is of a second field of the set of fields, the second view including the received field-level comment, a first indicator of the first field, the received second field-level comment and a second indicator of the first field. In some examples, the second record-level visual indicator may indicate that the second field-level comment is associated with a second data record. The operations of 1115 may be performed according to the methods described herein. In some examples, aspects of the operations of 1115 may be performed by a user input component as described with reference to FIGS. 7 through 9.

At 1120, the application server may receive, via the first graphical user interface, a second user input to edit the field-level comment for the first field. In some examples, the first view may include the edited field-level comment and the first field-level visual indicator indicating that the edited field-level comment is associated with the first field. In some examples, the second view may include the edited field-level comment and the second record-level visual indicator indicating that the edited field-level comment is associated with the first data record. The operations of 1120 may be performed according to the methods described herein. In some examples, aspects of the operations of 1120 may be performed by an editing component as described with reference to FIGS. 7 through 9.

At 1125, the application server may render a second graphical user interface including a second view of a set of data records including the first data record. In some examples, the second view omits the first field and includes the received field-level comment and a second record-level visual indicator indicating that the field-level comment is associated with the first data record. The operations of 1125 may be performed according to the methods described herein. In some examples, aspects of the operations of 1125 may be performed by a second view rendering component as described with reference to FIGS. 7 through 9.

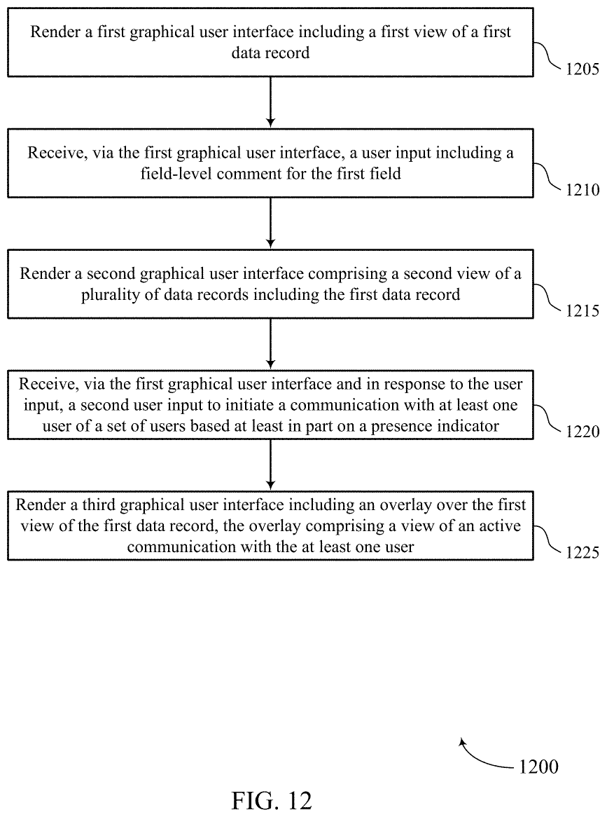

FIG. 12 shows a flowchart illustrating a method 1200 that supports implementing field-level comments and presence detection in accordance with aspects of the present disclosure. The operations of method 1200 may be implemented by an application server or its components as described herein. For example, the operations of method 1200 may be performed by a data processing module as described with reference to FIGS. 7 through 9. In some examples, an application server may execute a set of instructions to control the functional elements of the application server to perform the functions described below. Additionally or alternatively, an application server may perform aspects of the functions described below using special-purpose hardware.

At 1205, the application server may render a first graphical user interface including a first view of a first data record. In some examples, the first view may include a first field of a set of fields of the first data record. The operations of 1205 may be performed according to the methods described herein. In some examples, aspects of the operations of 1205 may be performed by a first view rendering component as described with reference to FIGS. 7 through 9.

At 1210, the application server may receive, via the first graphical user interface, a user input including a field-level comment for the first field. In some examples, the first view may include the received field-level comment and a first field-level visual indicator indicating that the received field-level comment is associated with the first field. The operations of 1210 may be performed according to the methods described herein. In some examples, aspects of the operations of 1210 may be performed by a user input component as described with reference to FIGS. 7 through 9.

At 1215, the application server may render a second graphical user interface including a second view of a set of data records including the first data record. In some examples, the second view omits the first field and includes the received field-level comment and a second record-level visual indicator indicating that the field-level comment is associated with the first data record. The operations of 1215 may be performed according to the methods described herein. In some examples, aspects of the operations of 1215 may be performed by a second view rendering component as described with reference to FIGS. 7 through 9

At 1220, the application server may receive, via the first graphical user interface and in response to the user input, a second user input to initiate a communication with at least one user of a set of users based on a presence indicator. In some cases, the communication with the at least one user may include at least one of an audio communication, a video communication, a written communication, or a combination thereof. The operations of 1220 may be performed according to the methods described herein. In some examples, aspects of the operations of 1220 may be performed by a communication component as described with reference to FIGS. 7 through 9.

At 1225, the application server may render a third graphical user interface including an overlay over the first view of the first data record. The operations of 1225 may be performed according to the methods described herein. In some examples, aspects of the operations of 1225 may be performed by a communication component as described with reference to FIGS. 7 through 9.

A method for data processing is described. The method may include rendering a first graphical user interface including a first view of a first data record, the first view including a first field of a set of fields of the first data record, receiving, via the first graphical user interface, a user input including a field-level comment for the first field, where the first view further including the received field-level comment and a first field-level visual indicator indicating that the received field-level comment is associated with the first field, and rendering a second graphical user interface including a second view of a set of data records including the first data record, where the second view omits the first field and includes the received field-level comment and a second record-level visual indicator indicating that the field-level comment is associated with the first data record.

An apparatus for data processing is described. The apparatus may include a processor, memory coupled with the processor, and instructions stored in the memory. The instructions may be executable by the processor to cause the apparatus to render a first graphical user interface including a first view of a first data record, the first view including a first field of a set of fields of the first data record, receive, via the first graphical user interface, a user input including a field-level comment for the first field, where the first view further including the received field-level comment and a first field-level visual indicator indicating that the received field-level comment is associated with the first field, and render a second graphical user interface including a second view of a set of data records including the first data record, where the second view omits the first field and includes the received field-level comment and a second record-level visual indicator indicating that the field-level comment is associated with the first data record.

Another apparatus for data processing is described. The apparatus may include means for rendering a first graphical user interface including a first view of a first data record, the first view including a first field of a set of fields of the first data record, means for receiving, via the first graphical user interface, a user input including a field-level comment for the first field, where the first view further including the received field-level comment and a first field-level visual indicator indicating that the received field-level comment is associated with the first field, and means for rendering a second graphical user interface including a second view of a set of data records including the first data record, where the second view omits the first field and includes the received field-level comment and a second record-level visual indicator indicating that the field-level comment is associated with the first data record.

A non-transitory computer-readable medium storing code for data processing is described. The code may include instructions executable by a processor to render a first graphical user interface including a first view of a first data record, the first view including a first field of a set of fields of the first data record, receive, via the first graphical user interface, a user input including a field-level comment for the first field, where the first view further including the received field-level comment and a first field-level visual indicator indicating that the received field-level comment is associated with the first field, and render a second graphical user interface including a second view of a set of data records including the first data record, where the second view omits the first field and includes the received field-level comment and a second record-level visual indicator indicating that the field-level comment is associated with the first data record.

Some examples of the method, apparatuses, and non-transitory computer-readable medium described herein may further include operations, features, means, or instructions for receiving, via the first graphical user interface, a second user input including a second field-level comment, where the first view further includes the received field-level comment and the received second field-level comment, and where the first field-level visual indicator indicates a number of field-level comments associated with the first field.

In some examples of the method, apparatuses, and non-transitory computer-readable medium described herein, the second view may include the received field-level comment and the received second field-level comment, and the second record-level visual indicator indicates that the second field-level comment is associated with the first data record or a second data record.

In some examples of the method, apparatuses, and non-transitory computer-readable medium described herein, the second field-level comment is of a second field of the set of fields, the second view including the received field-level comment, a first indicator of the first field, the received second field-level comment and a second indicator of the first field, and the second record-level visual indicator indicates that the second field-level comment is associated with a second data record.

Some examples of the method, apparatuses, and non-transitory computer-readable medium described herein may further include operations, features, means, or instructions for receiving, via the first graphical user interface, a second user input to edit the field-level comment for the first field, where the first view further includes the edited field-level comment and the first field-level visual indicator indicating that the edited field-level comment is associated with the first field, and where the second view including the edited field-level comment and the second record-level visual indicator indicating that the edited field-level comment is associated with the first data record.

Some examples of the method, apparatuses, and non-transitory computer-readable medium described herein may further include operations, features, means, or instructions for receiving, via the second graphical user interface, a second user input to edit the field-level comment for the first field, where the second view omits the received field-level comment and includes the edited field-level comment.

In some examples of the method, apparatuses, and non-transitory computer-readable medium described herein, the first field-level visual indicator is the same as the second record-level visual indicator.

In some examples of the method, apparatuses, and non-transitory computer-readable medium described herein, the first field-level visual indicator is different from the second record-level visual indicator.

In some examples of the method, apparatuses, and non-transitory computer-readable medium described herein, the first view further includes a third indicator indicating that the received field-level comment is unread.

Some examples of the method, apparatuses, and non-transitory computer-readable medium described herein may further include operations, features, means, or instructions for receiving, via the first graphical user interface and in response to the user input, a second user input to initiate a communication with at least one user of a set of users based on a presence indicator, where the first view further includes the presence indicator indicating a presence of each user of the set of users.

Some examples of the method, apparatuses, and non-transitory computer-readable medium described herein may further include operations, features, means, or instructions for rendering a third graphical user interface including an overlay over the first view of the first data record, the overlay including a view of an active communication with the at least one user.

In some examples of the method, apparatuses, and non-transitory computer-readable medium described herein, the communication with the at least one user includes at least one of an audio communication, a video communication, a written communication, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for data processing at an application server, comprising:
rendering a first graphical user interface comprising a first view of a first data record comprising a plurality of fields, the first view comprising a first field of the plurality of fields;
receiving, via the first graphical user interface, a user input including a field-level comment for the first field, wherein the field-level comment is associated at the database object level for the first field,
wherein the first view further comprises a subsection including the received field-level comment and a first field-level visual indicator indicating that the received field-level comment is associated with the first field; and
rendering a second graphical user interface comprising a second view of a plurality of data records including the first data record,
wherein the second view omits the plurality of fields including the first field and imports the received field-level comment from the first view, the second view comprising the plurality of data records including the first data record, and a second record-level visual indicator indicating that the first data record includes the field-level comment.

2. The method of claim 1, further comprising:
receiving, via the first graphical user interface, a second user input including a second field-level comment, wherein the first view further comprises the received field-level comment and the received second field-level comment, and wherein the first field-level visual indicator indicates a number of field-level comments associated with the first field.

3. The method of claim 2, wherein:
the second view comprises the received field-level comment and the received second field-level comment, and
the second record-level visual indicator indicates that the second field-level comment is associated with the first data record or a second data record.

4. The method of claim 2, wherein:
the second field-level comment is of the first field of the plurality of fields, the second view comprising the imported subsection including the received field-level comment, a first indicator identifying the first field associated with the first data record, the received second field-level comment and a second indicator identifying the first field associated with a second data record, and
the second record-level visual indicator indicates that the second field-level comment is associated with the second data record.

5. The method of claim 1, further comprising:
receiving, via the first graphical user interface, a second user input to edit the field-level comment for the first field, wherein the first view further comprises the edited field-level comment and the first field-level visual indicator indicating that the edited field-level comment is associated with the first field, and wherein the second view comprises the edited field-level comment and the second record-level visual indicator indicating that the edited field-level comment is associated with the first data record.

6. The method of claim 1, further comprising:
receiving, via the second graphical user interface, a second user input to edit the field-level comment for the first field, wherein the second view omits the received field-level comment and comprises the edited field-level comment.

7. The method of claim 1, wherein the first field-level visual indicator is the same as the second record-level visual indicator.

8. The method of claim 1, wherein the first field-level visual indicator is different from the second record-level visual indicator.

9. The method of claim 1, wherein the first view further comprises a third indicator indicating that the received field-level comment is unread.

10. The method of claim 1, further comprising:
receiving, via the first graphical user interface and in response to the user input, a second user input to initiate a communication with at least one user of a plurality of users based at least in part on a presence indicator, wherein the first view further comprises the presence indicator indicating a presence of each user of the plurality of users.

11. The method of claim 10, further comprising:
rendering a third graphical user interface comprising an overlay over the first view of the first data record, the overlay comprising a view of an active communication with the at least one user.

12. The method of claim 10, wherein a dataset for the plurality of fields is associated with at least one of reports, report types, data objects, data sets, or a combination thereof.

13. An apparatus for data processing, comprising:
a processor,
memory coupled with the processor; and
instructions stored in the memory and executable by the processor to cause the apparatus to:
render a first graphical user interface comprising a first view of a first data record comprising a plurality of fields, the first view comprising a first field of the plurality of fields;
receive, via the first graphical user interface, a user input including a field-level comment for the first field, wherein the field-level comment is associated at the database object level for the first field,
wherein the first view further comprises a subsection including the received field-level comment and a first field-level visual indicator indicating that the received field-level comment is associated with the first field; and
render a second graphical user interface comprising a second view of a plurality of data records including the first data record,
wherein the second view omits the plurality of fields including the first field and imports the received field-level comment from the first view, the second view comprising the plurality of data records including the first data record, and a second record-level visual indicator indicating that the first data record includes the field-level comment.

14. The apparatus of claim 13, wherein the instructions are further executable by the processor to cause the apparatus to:
receive, via the first graphical user interface, a second user input including a second field-level comment, wherein the first view further comprises the received field-level comment and the received second field-level comment, and wherein the first field-level visual indicator indicates a number of field-level comments associated with the first field.

15. The apparatus of claim 14, wherein:
the second view comprises the received field-level comment and the received second field-level comment, and
the second record-level visual indicator indicates that the second field-level comment is associated with the first data record or a second data record.

16. The apparatus of claim 14, wherein:
the second field-level comment is of the first field of the plurality of fields, the second view comprising the imported subsection including the received field-level comment, a first indicator identifying the first field associated with the first data record, the received second field-level comment and a second indicator identifying the first field associated with a second data record, and
the second record-level visual indicator indicates that the second field-level comment is associated with the second data record.

17. The apparatus of claim 13, wherein the instructions are further executable by the processor to cause the apparatus to:
receive, via the first graphical user interface, a second user input to edit the field-level comment for the first field, wherein the first view further comprises the edited field-level comment and the first field-level visual indicator indicating that the edited field-level comment is associated with the first field, and wherein the second view comprises the edited field-level comment and the second record-level visual indicator indicating that the edited field-level comment is associated with the first data record.

18. The apparatus of claim 13, wherein the instructions are further executable by the processor to cause the apparatus to:
receive, via the second graphical user interface, a second user input to edit the field-level comment for the first field, wherein the second view omits the received field-level comment and comprises the edited field-level comment.

19. A non-transitory computer-readable medium storing code for data processing, the code comprising instructions executable by a processor to:
render a first graphical user interface comprising a first view of a first data record comprising a plurality of fields, the first view comprising a first field of the plurality of fields;
receive, via the first graphical user interface, a user input including a field-level comment for the first field, wherein the field-level comment is associated at the database object level for the first field,
wherein the first view further comprises a subsection including the received field-level comment and a first field-level visual indicator indicating that the received field-level comment is associated with the first field; and
render a second graphical user interface comprising a second view of a plurality of data records including the first data record,
wherein the second view omits the plurality of fields including the first field and imports comprises the received field-level comment from the first view, the second view comprising the plurality of data records including the first data record, and a second record-level visual indicator indicating that the first data record includes the field-level comment.

20. The non-transitory computer-readable medium of claim 19, wherein the instructions are further executable to:
receive, via the first graphical user interface, a second user input including a second field-level comment, wherein the first view further comprises the received field-level comment and the received second field-level comment, and wherein the first field-level visual indicator indicates a number of field-level comments associated with the first field.
